(19) United States
(12) Patent Application Publication
(10) Pub. No.: US 2024/0037862 A1
(43) Pub. Date: Feb. 1, 2024

(54) SYSTEM AND METHOD FOR PROVIDING A PLATFORM FOR VIRTUAL AUGMENTED REALITY FITTING OF AN ITEM

(71) Applicant: Margot Osmundsen-Repp, Kent, OH (US)

(72) Inventor: Margot Osmundsen-Repp, Kent, OH (US)

(21) Appl. No.: 17/873,940

(22) Filed: Jul. 26, 2022

(51) Int. Cl. G06T 19/00; G06Q 30/06

(52) U.S. Cl. CPC G06T 19/006; G06Q 30/0643; G06T 2200/24

(57) ABSTRACT

A system for providing a virtual augmented reality fitting of an item. At least one user computing device in operable connection with a user network. An application server in operable communication with the user network to host an application system for providing a platform for virtually fitting a product via an augmented reality module. The application system having a user interface module for providing access to the application system through the user computing device. The augmented reality module is in operable communication with an item database for storing superimposable images of a plurality of items. An image capture module captures video and transmits the video to the augmented reality module which superimposes an image of the item onto the video. The item database includes one or more selectable items to permit the display of the superimposable images of the user-selected items in real-time to provide a virtual fitting room.

### TECHNICAL FIELD

The embodiments generally relate to systems and methods for fitting products and more particularly to a virtual augmented reality system for fitting a product.

### BACKGROUND

Virtual fitting rooms are the online equivalent of in-store changing rooms. These platforms allow shoppers to try on clothes to confirm size, fit, or style virtually rather than physically using body scanners, 3-dimensional (3D) modeling systems, or avatars. Users can shop items and view the characteristics of the item in reference to their body proportions.

Augmented reality virtual fitting rooms operate by superimposing a 3D model or picture of a garment or accessory within the live video feed of the customer. The superimposed 3D model or picture of the garment or accessory will then track to movements of the customer to create the illusion that the customer is wearing the virtual item. Typically, these systems utilize a smartphone camera, webcam, or other camera to function. The video feed is output to a display on a computing device (e.g., a laptop, desktop, smartphone, etc.).

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein relate to a system for providing a virtual augmented reality fitting of an item. At least one user computing device in operable connection with a user network. An application server in operable communication with the user network to host an application system for providing a platform for virtually fitting a product via an augmented reality module. The application system having a user interface module for providing access to the application system through the user computing device. The augmented reality module is in operable communication with an item database for storing superimposable images of a plurality of items. An image capture module captures video and transmits the video to the augmented reality module which superimposes an image of the item onto the video. The item database includes one or more selectable items to permit the display of the superimposable images of the user-selected items in real-time to provide a virtual fitting room.

The embodiments allow for a user to view a superimposed image of an item on their body (e.g., their hand) in real-time. This provides a realistic view of the item, rather than a representation of the item on an avatar, still image, or model. In one example, the user can select from various rings which they may virtually try on using the system described herein. This allows the user to have a realistic representation of ring's appearance on their hand without the need to travel to a brick-and-mortar store location.

In one aspect, the image capture module is in operable communication with a display module, the display module to display the video on a display of the user computing device.

In one aspect, the image capture module is operable to capture user movements.

In one aspect, the video is displayed in real-time on a display of the user computing device.

In one aspect, a user module permits a user a create a user account associated with a plurality of user preferences.

In one aspect, a user database stores the user preferences and to apply the user preferences to a recommendation for one or more items.

In one aspect, the user database stores one or more recorded fitting sessions.

In one aspect, the item database stores a plurality of item characteristics.

In one aspect, a communication module to permit communication between the user computing device and a third-party computing device.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of a computing system, according to some embodiments;

FIG. 2 illustrates a block diagram of a computing system and an application program, according to some embodiments;

FIG. 3 illustrates a block diagram of the application program, according to some embodiments;

FIG. 4 illustrates a flowchart of a method for providing a virtual augmented reality fitting room for various items, according to some embodiments;

FIG. 5 illustrates a screenshot of the ring superimposed on a live background image, according to some embodiments; and

FIG. 6 illustrates a screenshot of the ring superimposed on imagery of a hand which is displayed in real-time, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, and/or computer program product at any possible technical detail level of integration. A computer program product can include, among other things, a computer-readable storage medium having computer-readable program instructions thereon for causing a processor to carry out aspects of the present disclosure.

In general, the embodiments described herein relate to a virtual augmented reality fitting system allowing a user to view digital representations of a ring or other item on their hand or other body part(s) using their smart device. In one example, the user places their hand in view of a camera (such as the camera on their smartphone). A digital image of a ring (or other item) may then be superimposed onto their hand to display the appearance of the ring on their hand. This eliminates the need to go to a store to try on the ring. This may be advantageous in that the user does not need to communicate with a salesperson or other store personnel which may be stressful to some.

As used herein, the term “item” and “accessory item” may relate to various known apparel accessories and jewelry which can be digitally depicted and superimposed onto the body of the user. The item may be those that are worn on the hand and/or wrist such that the user can easily position their hand in view of a smartphone camera while operating the smartphone with their other hand. This reduces the need for a separate user to capture the image/video of the user or for the user to use an external camera such as a webcam.

The embodiments herein are described in an exemplary manner using a ring, wherein the user is using the virtual augmented reality fitting system to view various rings on their finger(s). One skilled in the arts will readily understand that the item and body parts which apply to the fitting of the item may be changed without deterring from the present embodiments.

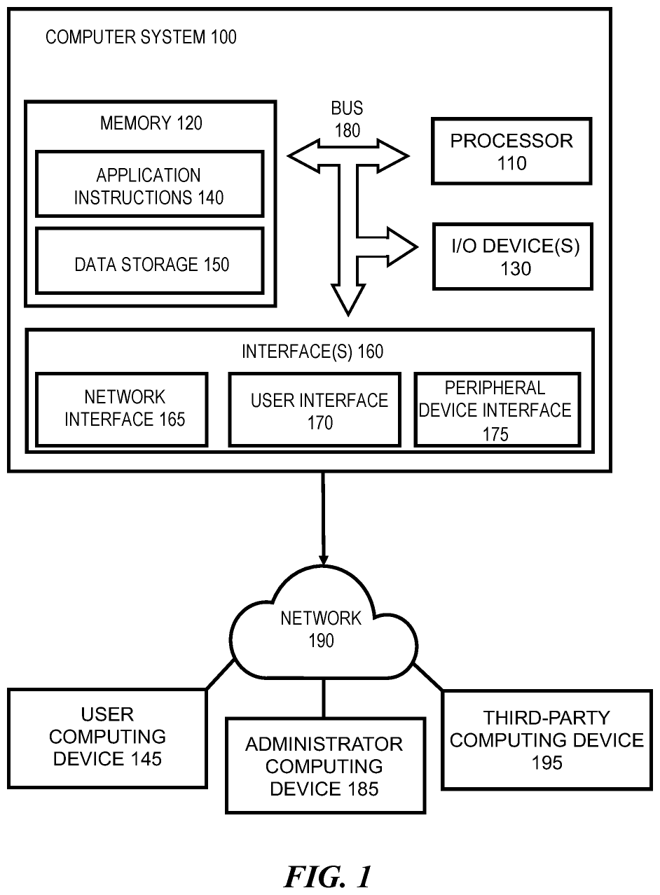

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized by the user to interact with the various functionalities of the system including the ability to capture video and enable the virtual augmented reality fitting of an item. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

In some embodiments, the user operates the camera on their smartphone to view a live video feed of their hand. The user then selects in real-time or preselects one or more rings to try on in the virtual augmented reality fitting system. In such, a live video feed of the user's hand and each ring virtually positioned on the hand is displayed to the user.

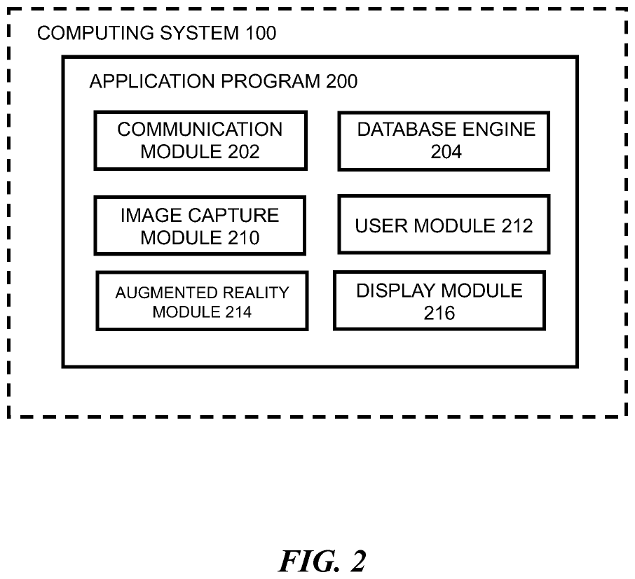

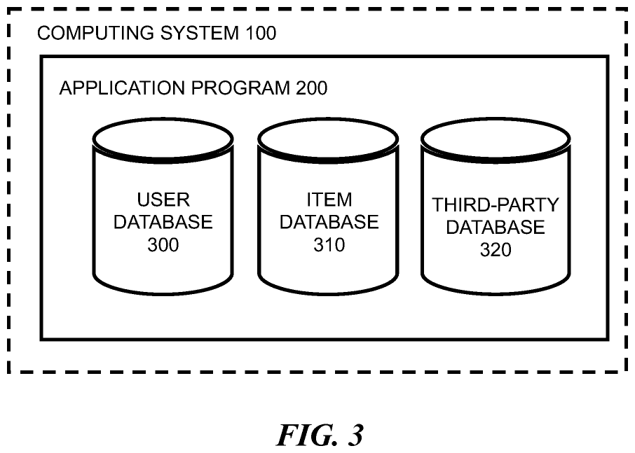

FIGS. 2 and 3 illustrate an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200, and FIG. 3 is a block diagram showing the various databases utilized by the various modules.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, an image capture module 210, a user module 212, an augmented reality module 214, and a display module 216.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195.

In some embodiments, the communication module 202 allows the user to communicate with other users, communicate with item purveyors, product designers, technical support personnel, salespeople, etc. during a virtual fitting session.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

In some embodiments, the database engine 204 is in operable communication with an item database configured to store item details including items size, color, dimensions, fitting details, options, etc. The database engine 204 may also be in operable communication with a user database to store user data including user preferences, user hand and body sizing, etc.

In some embodiments, the image capture module 210 is in operable communication with the camera of the computing device (i.e., their smartphone) to receive image data and transmit the image data in real-time to the display of the computing device.

In some embodiments, the user module 212 facilitates the creation of a user account for the application system. The user module 212 may allow the user to create a communications profile which allows them to engage in the virtual fitting room while storing preferences, storing recordings of previously fitted items, storing previously purchased items, and the like. Alternatively, the user module 212 may be utilized by a third-party user, such as by a provider of goods to upload items which they provide (e.g., uploading a plurality of rings which may be virtually fitted using the system described herein).

In some embodiments, the user database may store individualized uses profiles, body imaging profiles, and avatars created by 3D modeling of each user's individual body profile. The item database may be accessible by a network-based marketplace. According to the present embodiments, the electronic marketplace communicates with individual user's remote computing devices via the communications network and includes software for the generation of a graphical user interface (GUI) for a virtual fitting room accessible by each user.

In some embodiments, the augmented reality module 214 is configured to display a superimposed image of one or more items over a live video of the user. For example, the augmented reality module 214 displays a superimposed image of one or more rings on the hand of a user. The augmented reality module 214 allows for a live video feed of the item and body part to be viewed in real time using the user's computing device.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 may be in communication with the augmented reality module 214 to display the video feed in real time.

FIG. 3 illustrates the computing system 100 in operable communication with the application program 200 having a plurality of databases in communication thereto. A user database 300 is operable to store user information such as user preferences, user profile information, historical usage data, historical content, communications information, etc. The user database 300 may also store previously recorded virtual fitting sessions. This may be advantageous in allowing for item comparisons. The item database 310 stores items submitted by and associated with each user and/or third-party user. The third-party database 320 stores third-party information such as preferences, historical usage data, communication content received, interactions, etc. The third-party database 320 may store online marketplace information related to a product provider as well as third-party contact information to allow the user to communicate with the third-party.

In some embodiments, the system generates one or more recommendations for the user based on the user's interactions within their virtual fitting room, and/or one or more electronic virtual clothing stores operated by a designer, retailer, or manufacturer that lists items in the item database. These user interactions with the various functionalities of the system may include purchases, item selections, category selections, searches, response to solicitations and the like. When a user-selected item does not provide the proper fit for the user's unique body shape, size, etc., the system may optionally offer the user alternative items and/or accessories from the item listing that will provide a better fit for the user's body used on the system's comparison of the user's body and shape characteristics to item profiles available in the item catalog.

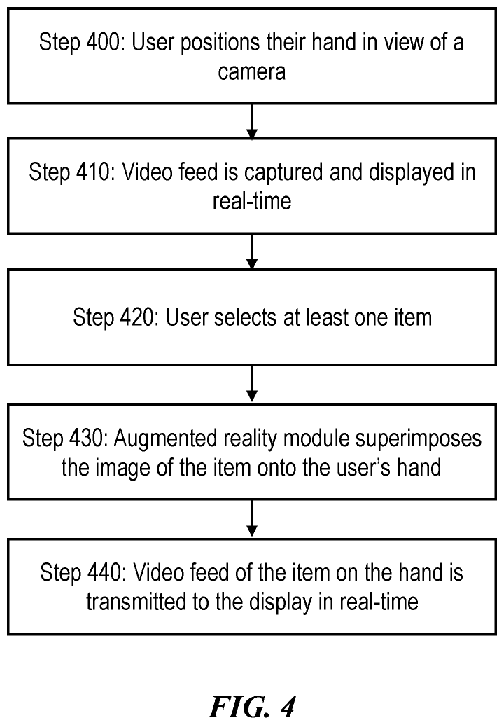

FIG. 4 illustrates a flowchart of a method for providing a virtual augmented reality fitting room. In step 400, the user positions their hand in view of a camera. The camera may be a component of a smartphone or another camera (i.e., video capture and recording device) in operable communication with a computing device. In step 410, the video feed is captured of the user's hand and displayed, in real-time on the display of the computing device. In step 420, the user selects an item (e.g., a ring) which they would like to try on virtually. In step 430, the augmented reality module superimposes the digital image of the item on the user's body. For example, the augmented reality module superimposes an image of a ring on the user's hand. In step 440, the video feed is transmitted to the display in real-time by the augmented reality module. In such, the user can view the ring on their hand as their hand and/or fingers move and turn in natural motions.

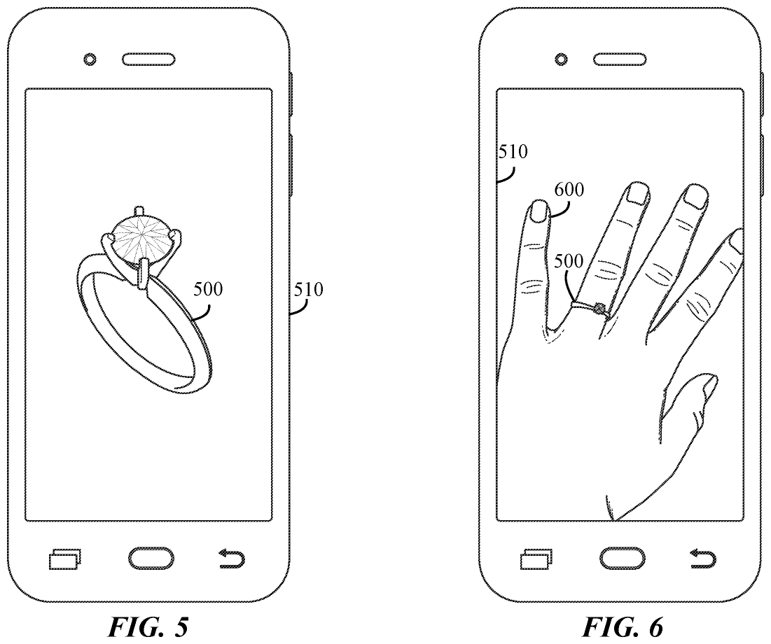

FIG. 5 illustrates a screenshot of the ring 500 superimposed on a background imagery which is captured by the camera of the smartphone 510 in real-time. The ring 500 may be selected by the user via a marketplace containing various rings or other items which are stored in the item database. The ring 500 size may be selected by the user by using touchscreen functionalities provided by the smartphone 510. For example, the user may zoom in or zoom out on the ring 500 to make the ring appear larger or smaller on the display of the smartphone 510. As shown in FIG. 6, the user may then position their hand 600 within view of the camera of the smartphone 510 such that the hand 600 position is captured on the display. The user may orient their hand 600 to fit the superimposed ring 500 on their hand 600 to view how the ring 500 would appear if worn.

In some embodiments, the superimposed ring 500 may automatically adjust to the size of the hand 600. For example, the image capture module 210 senses the position of the hand and automatically resizes the ring 500 to properly fit the hand.

In some embodiments, the user may adjust their hand 600 positioned to fit the ring 500 to their hand. For example, the user may move their hand closer to or further away from the camera until the ring 500 is sized appropriately on the hand 600.

In some embodiments, one or more controls may be positioned on the display of the device. The controls may allow for the user to adjust the size of the ring 500 and/or adjust the orientation of the ring during a virtual fitting session. This allows the user to control the appearance of the superimposed ring 500 to ensure it appears to fit the hand properly in the augmented reality virtual fitting room.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for providing a virtual augmented reality fitting of an item, the system comprising:
at least one user computing device in operable connection with a user network;
an application server in operable communication with the user network, the application server configured to host an application system for providing a platform for virtually fitting a product via an augmented reality module, the application system having a user interface module for providing access to the application system through the user computing device, the augmented reality module in operable communication with an item database for storing superimposable images of a plurality of items; and
an image capture module to capture video and transmit the video to the augmented reality module, wherein the augmented reality module superimposes an image of the item onto the video.

2. The system of claim 1, wherein the image capture module is in operable communication with a display module, the display module to display the video on a display of the user computing device.

3. The system of claim 2, wherein the video is displayed in real-time.

4. The system of claim 1, further comprising a user module to permit a user a create a user account associated with a plurality of user preferences.

5. The system of claim 4, further comprising a user database to store the user preferences and to apply the user preferences to a recommendation for one or more items.

6. The system of claim 1, wherein the item database stores a plurality of item characteristics.

7. The system of claim 1, further comprising a communication module to permit communication between the user computing device and a third-party computing device.

8. A system for providing a virtual augmented reality fitting of an item, the system comprising:
at least one user computing device in operable connection with a user network;
an application server in operable communication with the user network, the application server configured to host an application system for providing a platform for virtually fitting a product via an augmented reality module, the application system having a user interface module for providing access to the application system through the user computing device, the augmented reality module in operable communication with an item database for storing superimposable images of a plurality of items; and
an image capture module to capture video and transmit the video to the augmented reality module, wherein the augmented reality module superimposes an image of the item onto the video, wherein the item database includes one or more selectable items to permit the display of the superimposable images of the user-selected items in real-time to provide a virtual fitting room.

9. The system of claim 8, wherein the image capture module is in operable communication with a display module, the display module to display the video on a display of the user computing device.

10. The system of claim 9, wherein the image capture module is operable to capture user movements

11. The system of claim 10, wherein the video is displayed in real-time on a display of the user computing device.

12. The system of claim 11, further comprising a user module to permit a user a create a user account associated with a plurality of user preferences.

13. The system of claim 12, further comprising a user database to store the user preferences and to apply the user preferences to a recommendation for one or more items.

14. The system of claim 13, wherein the user database stores one or more recorded fitting sessions.

15. The system of claim 14, wherein the item database stores a plurality of item characteristics.

16. The system of claim 15, further comprising a communication module to permit communication between the user computing device and a third-party computing device.

17. A method for providing a virtual augmented reality fitting of an item, the method comprising the steps of:
positioning a hand in view of a camera in operable communication with a user computing device;
capturing, via an image capture module, a video feed of the hand;
displaying, via a display module, the video feed on a display of the user computing device;
selecting at least one item stored in an item database; and
superimposing, via an augmented reality module, an image of the at least one item onto the hand.

18. The method of claim 17, further comprising a user database to store a plurality user preferences and to apply the user preferences to a recommendation for one or more items.

19. The method of claim 17, wherein the user database stores one or more recorded fitting sessions to permit item comparison via the user.

20. The method of claim 17, further comprising a communication module to permit communication between the user computing device and a third-party computing device.
